(19) United States
(12) Patent Application Publication
(10) Pub. No.: US 2023/0173877 A1
(43) Pub. Date: Jun. 8, 2023

(54) Systems and Methods for Control of Interior and Seat Temperature

(71) Applicant: Atlis Motor Vehicles, Inc., Mesa, AZ (US)

(72) Inventors: Mark Hanchett, Mesa, AZ (US); Benoit le Bourgeois, Mesa, AZ (US)

(73) Assignee: Atlis Motor Vehicles, Inc., Mesa, AZ (US)

(21) Appl. No.: 18/102,397

(22) Filed: Jan. 27, 2023

Related U.S. Application Data
(60) Provisional application No. 63/305,222, filed on Jan. 31, 2022.
(60) Provisional application No. 63/314,796, filed on Feb. 28, 2022.

(51) Int. Cl. B60H 1/00; B60H 1/22

(52) U.S. Cl. CPC B60H 1/0073; B60H 1/00285; B60H 1/00792; B60H 1/00821; B60H 1/2215

(57) ABSTRACT

In an example embodiment, a controller controls the HVAC system, dampers, fans, and heater/coolers in seats to heat or cool the interior and the seats to a desired temperature. The controller may control the temperature and/or the flow of air through a plurality of ducts and the heater/coolers in the seats to heat or cool regions of the interior and the seats to a desired temperature.

### BACKGROUND

Embodiments of the present invention relate centrally controlling the environment inside a vehicle including the temperature of a seat.

In conventional vehicles, controlling the temperature of the environment inside a vehicle is separate from controlling the temperature of the seats. Conventional vehicles may include heaters that heat the seat; however, the temperature of the seat is controlled separately from controlling the temperature of the air inside the cabin. Passengers would benefit from the same controller centrally controlling the temperature of the air inside the cabin and the temperature of the seats.

### SUMMARY

In an example embodiment, a central environmental controller (e.g., control circuit, processing circuit, microprocessor) controls both the HVAC system that sets the temperature of the air in the interior (e.g., inside the cabin) of the vehicle and the heater/coolers in the seats that set the temperature of the one or more seats. The central environmental controller receives information from sensors (e.g., temperature sensors) that are positioned around the interior of the vehicle and in one or more of the seats of the vehicle. The user sets a desired temperature for the interior of the vehicle via a user interface. The central environmental controller controls the HVAC system so that the air temperature inside the cabin is at or near the desired temperature as specified by the user. The environment controller also controls the heater/cooler in each seat so that the temperature of the cover or cushion of the seat is the same as the desired temperature set by the user. The temperature to which the seat is heated or cooled is the same temperature to which the interior of the vehicle is heated or cooled. As the desired temperature is changed, the temperature of the air in the cabin and the seat also change.

In another example embodiment, the central environment controller controls the heater/cooler in the seat so that the temperature of the seat is the desired temperature plus or minus an offset so that the temperature of the seat may be greater than or less than the temperature in the interior of the vehicle. However, the temperature of the seat is related to the temperature of the interior and is controlled (e.g., monitored) by the same controller that regulates the temperature of the interior. Further, as the desired temperature is increased or decreased, the temperature of the seat increases or decreases in accordance with the desired temperature plus or minus the offset.

In any example embodiment, the temperature of the environment inside the vehicle (e.g., interior) and the temperature of the seats are related to the desired temperature provided by the user. Further, the temperature of the interior and the seats are controlled by the same central environmental controller as opposed to having a first controller for controlling the temperature of the interior (e.g., via the HVAC system) and a second unrelated and independent controller for controlling the temperature of each seat.

The vehicle further includes a plurality of ducts and dampers distributed throughout the vehicle. In an example embodiment, a hollow central portion of one or more pillars (e.g., A-pillar, B-pillar, C-pillar) are used as ducts to distribute conditioned air to various portions of the vehicle. Ducts may further include a hollow portion of the roof, a hollow portion of the floor and/or a hollow portion of a door. Ducts include one or more outlets that releases air from the duct into the interior of the vehicle. The distribution of the ducts and outlets around the interior of the vehicle permits the air to be delivered at a lower velocity into the interior than in a conventional vehicle that has ducts solely in the dashboard. Further, the distribution of the ducts and outlets around the interior enable the central environment controller to maintain a desired temperature in a particular region (e.g., zone) of the interior of the vehicle. The central environment controller may use information from temperature sensors positioned around the interior the vehicle to form a temperature map to enable the central environment controller to determine where conditioned air should be delivered via the ducts into the interior to reach or maintain a desired temperature.

### BRIEF DESCRIPTION OF THE DRAWING

Embodiments of the present invention will be described with reference to the figures of the drawing. The figures present non-limiting example embodiments of the present disclosure. Elements that have the same reference number are either identical or similar in purpose and function, unless otherwise indicated in the written description.

FIG. 1 is a diagram of a prior art seat heater.

FIG. 2 is a diagram of a top view of the interior of a vehicle according to various aspects of the present disclosure;

FIG. 3A is a diagram of an example embodiment of an environmental control interface.

FIG. 3B is a diagram of another example embodiment of an environmental control interface.

FIG. 4 is a diagram of an example embodiment of a central environmental controller.

FIG. 5 is a diagram of an example embodiment of pillars in a vehicle.

FIG. 6 is a diagram of air distribution via the pillars and the roof of the vehicle.

FIG. 7 is a diagram of air distribution via the pillars and the floor of the vehicle.

FIG. 8 is a diagram of air distribution via the pillars and the doors of the vehicle.

FIG. 9 is a diagram of a temperature map of the interior of the vehicle.

FIG. 10 is a diagram of a temperature map of regions of the interior of the vehicle.

### DETAILED DESCRIPTION

### Overview

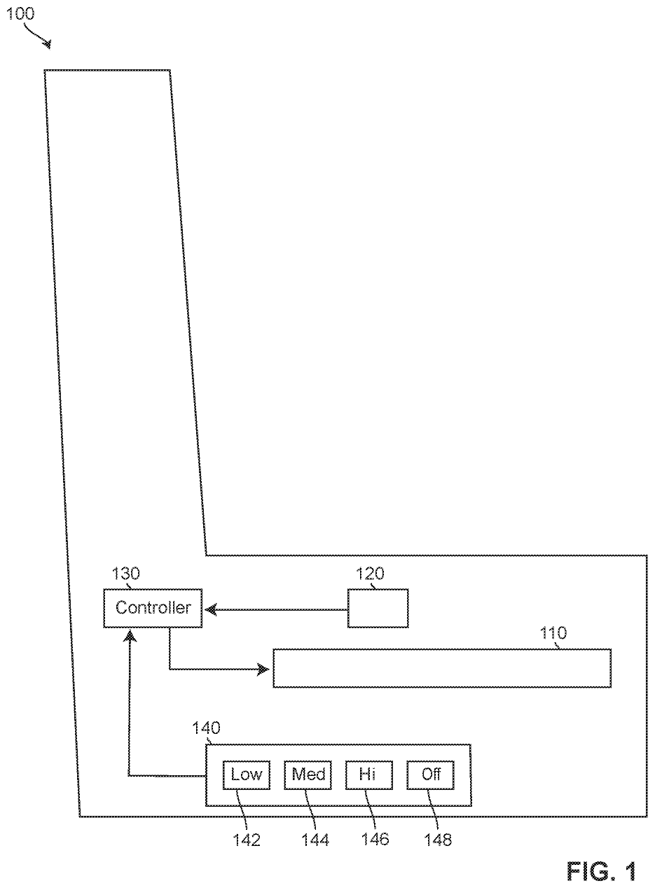

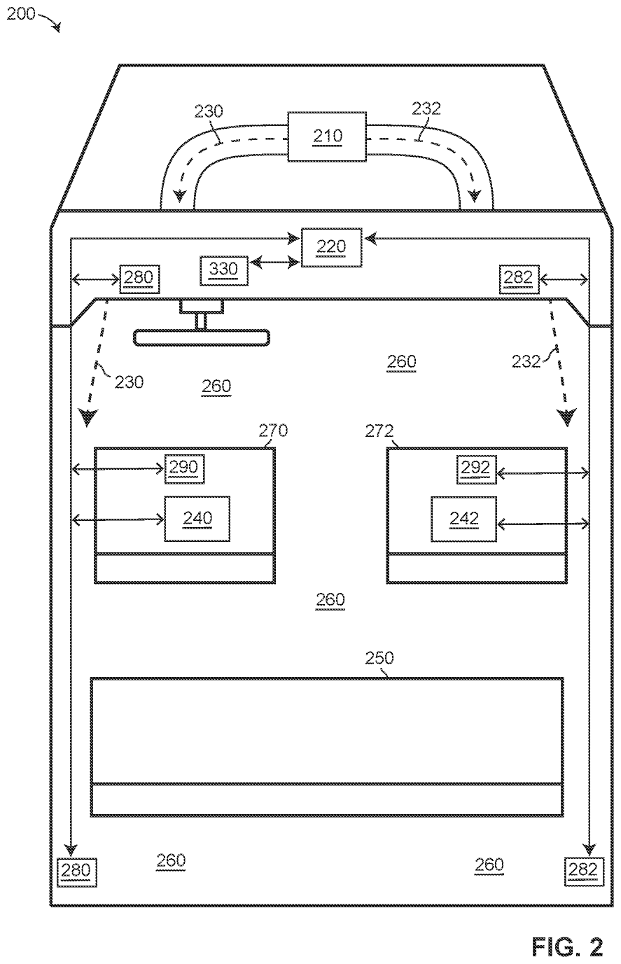

In conventional vehicles, the seats may be heated. However, the control of the temperature of each seat is separate from and independent of the other seats and the HVAC system that heats and cools the interior of the vehicle. In other words, in a conventional vehicle, the temperature of the seats and the temperature of the interior are not centrally monitored and/or controlled. A conventional seat is shown in FIG. 1. Seat 100 includes a heating element 110, a temperature sensor 120, a temperature selector 140 and a controller (e.g., thermostat, processing circuit, microprocessor) 130. The controller 130 causes the heating element 110 to generate heat until the temperature of the seat reaches the temperature specified by the temperature selector 140 as detected by the temperature sensor 120. The temperature sensor 120 reports the temperature of the seat to the controller 130, which turns the heating element off when the specified temperature is reached. The temperature selector 140 is a control that enables the user to specify the temperature of the seat. The user may turn the heating element 110 off by operating an off button 148. The user may specify a temperature by selecting a low button 142, a medium button 144, or a high button 146 for selecting a low temperature, a medium temperature, and a high temperature respectively. Each seat has a respective heating element 110, a respective temperature sensor 120, a respective temperature selector 140 and a respective controller 130. The controller 130 of a first seat does not control and/or monitor the temperature of a second seat. The controller 130 of a first seat operates separately and independently from the controller 130 in any other seat. The controller 130 does not control the operation of the HVAC system that heats or cools the interior of the vehicle.

An example embodiment of the present disclosure relates to a central environmental controller 220, also referred to as controller 220, that controls the HVAC system to heat or cool the interior (e.g., inside, cabin) 260 of a vehicle 200 and the heater/cooler in one or more seats to heat or cool the one or more seats (e.g., 270, 272). In an example embodiment, the controller 220 includes a touchscreen 330 that is part of the environmental control interface 340, also referred to as a user interface. The user may set a desired temperature of the interior 260 and the seats using the environmental control interface 340. In an example embodiment, the controller 220 controls the HVAC system 210 and a heater/cooler 240 and 242 to maintain the temperature of the interior 260, the temperature of a seat 270 and the temperature of the seat 272 to be at or near (e.g., within a threshold) the desired temperature.

In another example embodiment, the controller 220 controls the HVAC system 210 to maintain the temperature of the interior 260 at or near the desired temperature and the heater/cooler 240 and 242 to be at or near the desired temperature plus or minus an offset.

In another example embodiment, the controller 220 controls the HVAC system 210 to maintain the temperature of the interior 260 at or near a first desired temperature, controls the heater/cooler 240 to maintain the temperature of the seat 270 at or near a second desired temperature, and controls the heater/cooler 242 to maintain the temperature of the seat 272 at or near a third desired temperature.

Accordingly, the temperature of the interior 260 and the cover or cushion of the seat 270 or 272 are related to the desired temperature and thereby to each other. Further, the temperature of the interior 260 of the vehicle, the temperature of the seat 270, and the temperature of the seat 272 are all controlled and/or maintained by the controller 220 rather than being controlled by separate controllers that operate independently of each other.

In an example embodiment, only one of the seat 270 or the seat 272 includes a heater/cooler (e.g., 240, 242) and a temperature sensor (e.g., 290, 292).

In another example embodiment, the vehicle includes a plurality of ducts that deliver conditioned air from the HVAC system to various positions inside the vehicle. The positions include physicians at the front, in the center, and/or the rear of the interior the vehicle. Outlets from the ducts deliver the conditioned air at the various positions into the interior of the vehicle. In an example embodiment, the ducts include the hollow portions of the pillars (e.g., A-pillar, B-pillar, C-pillar) of the vehicle, and ducts or hollow portions in the floor, the roof and/or the doors. A plurality of dampers control the flow of the air through the ducts. The controller controls the dampers and thereby the distribution of air through the ducts. Further the controller controls the temperature of the air entering a duct. The controller controls the dampers and the temperature to heat the interior the vehicle, including regions (e.g., zones) of the interior, and the seat to one or more desired temperatures. In an example embodiment, the ducts in the control of the ducts are used to heat the seat to a desired temperature thereby eliminating the need for a heater/cooler from the seat. In another example embodiment, the ducts heat or cool the seat in addition to the conditioned air from the ducts.

### Hvac System

In an example embodiment, a heating, ventilation and air conditioning (“HVAC”) system 210 is used to heat, cool, and/or condition (e.g., decrease humidity, remove air-born particles) the air in the interior 260 of the vehicle 200. The HVAC system 210 is used to establish and/or maintain the temperature of the interior 260 of the vehicle 200. Air from the HVAC system 210 heats or cools objects or surfaces of the materials inside the vehicle 200. For example, the air from the HVAC system 210 heats the surfaces inside the interior 260, the seats (e.g., 270, 272, 250), objects placed inside the interior 260, and the people inside the interior 260.

The HVAC system 210 may intake air, work on the air to heat, cool, and/or condition the air and expel the air into the interior 260 of the vehicle 200 as an airflow 230 and/or an airflow 232. In another example embodiment, air from the HVAC system 210 enters the interior 560 of the vehicle 500 as airflows 630-632, 640-646, 650-652, 660, 670, 760, 770,860 and/or 870. The HVAC system 210 may provide air via an airflow at a temperature that is greater than the temperature of the interior 260/560 to heat the interior 260. The HVAC system 210 may provide air via an airflow at a temperature that is less than the temperature of the interior 260/560 to cool the interior 260/560.

In an example embodiment, the HVAC system 210 provides airflows 230, 630, 640-642 and/or 650, collectively referred to herein as driver-side airflow, to the driver-side of the interior 260/560 to heat or cool primarily the driver-side of the vehicle 200/500. The HVAC system 210 provides the airflow 232, 632, 644, 646 and/or 652, collectively referred to herein as passenger-side airflow, to the passenger-side of the interior 260/560 to heat or cool primarily the passenger-side of the vehicle 200/500. In an example embodiment, the desired temperature of the driver-side, and therefore the driver-side airflow, and the temperature of the passenger-side, and therefore the passenger-side airflow, are the same temperature. The user provides (e.g., specifies) the desired temperature to the controller 220 via the environmental control interface 340.

In another example embodiment, the HVAC system 210 provides the driver-side airflow to the driver-side of the interior 260/560 to heat or cool primarily the driver-side of the vehicle 200/500. The HVAC system 210 provides the passenger-side airflow to the passenger-side of the interior 260/560 to heat or cool primarily the passenger-side of the vehicle 200/500. The desired temperature of the driver-side, and therefore the driver-side airflow, may be set independently of the desired temperature of the passenger-side, and therefore the passenger-side airflow. The user may provide the desired temperature to the controller 220 via the environmental control interface 340.

In an example embodiment, the HVAC system 210 is controlled by the controller 220. The controller 220 controls the operation of the HVAC system 210. The controller 220 controls the temperature of the air in the driver-side airflow and the air in the passenger-side airflow. The controller 220 receives information from one or more temperature sensors (e.g., 280-282) regarding the temperature inside the interior 260/560 of the vehicle 200/500. The central environment controller 220 controls the HVAC system 210 which sets the temperature of the driver-side airflow and/or the passenger-side airflow so that the temperature of the interior 260/560 is at or near the desired temperature selected by the user. The controller 220 may use the temperature detected by the temperature sensors 280 and/or 282 to determine whether to increase or decrease the temperature of the driver-side airflow and/or the passenger-side airflow to bring the temperature of the interior 260/560 at or near the desired temperature.

### Seat Heater/Cooler

In an example embodiment, the heater/cooler 240 and the heater/cooler 242 are positioned in (e.g., inside, in the interior of) the seat 270 and the seat 272 respectively. The heater/cooler 240 and the heater/cooler 242 are adapted to provide heat to cause the temperature of the seat 270 and the seat 272 respectively to increase. The heater/cooler 240 and the heater/cooler 242 are adapted to remove heat (e.g., cool down, make cold) to cause the temperature of the seat 270 and the seat 272 respectively to decrease. In another embodiment, the heater/cooler 240 and/or the heater/cooler 242 include only a heating element to provide heat. In another embodiment, the heater/cooler 240 and/or the heater/cooler 242 include only a cooling element to remove heat. The heater/cooler 240 and the heater/cooler 242 are adapted to heat and/or cool a cover and/or a cushion of the seat 270 and the seat 272 respectively. A person sitting in the seat 270 or the seat 272 can feel the heat provided to or the heat removed from the cover and or the cushion of the seat.

The heater/coolers 240 and 242 generally are positioned below a cover or a cushion of the seat so that the user does not come into direct contact with the heater/coolers 240 or 242. Each seat may include one or more heater/coolers positioned at various locations (e.g., bottom, back, head rest, sides) of the seat to increase or decrease the temperature of the respective portions of the seats. In an example embodiment, the heater/coolers 240 and 242 are controlled by the controller 220. In an example embodiment, the controller 220 controls the operation of the heater/cooler 240 and the heater/cooler 242 to heat or cool the temperature of the seat 270 and 272 respectively to the same temperature. The temperature to which the seat is heated or cooled is specified by the user (e.g., desired temperature). In another example embodiment, the controller 220 controls the operation of the heater/cooler 240 and the heater/cooler 242 so that the seat 270 is heated or cooled to a different temperature than the seat 272. The user may specify a desired temperature for each seat.

In an embodiment, in which the heater/cooler 240 and/or the heater/cooler 242 comprises a plurality of heaters/coolers positioned at different locations in the seat 270 or the seat 272 respectively, the controller 220 may control the plurality of heater coolers to bring the different locations of the seat 270 or the seat 272 to the same temperature (e.g., the desired temperature). In another example embodiment, the plurality of heater/coolers 240 may bring the seat 270 to a first temperature (e.g., first desired temperature) and the plurality of heater/coolers 242 may bring the seat 272 to a second temperature (e.g., second desired temperature). The first temperature may be different than the second temperature.

In another example embodiment, each heater/cooler of the plurality of heater/coolers of the seat 270 are controlled by the controller 220 to bring each heater/cooler of the plurality of heater/coolers to the same temperature. In another example embodiment, the controller 220 controls one or more heater/coolers of the plurality of heater/coolers of the seat 270 to operate at a first temperature and one or more other heater/coolers of the plurality of heater/coolers of the seat 270 to operate at a second temperature. Regardless of the various temperatures of the different heater/coolers of the plurality of heater/coolers of the seat 270, the operation of each heater/cooler of the plurality of heater/coolers is controlled by the controller 220. The seat 270 may further include a plurality of temperature sensors for detecting the temperature of the various portions of the seat 270 that are heated or cooled by the various heater/coolers of the plurality of heater/coolers. The controller 220 receives the data from the plurality of temperature sensors for controlling the operation of the plurality of heaters/coolers. Another example embodiment, the temperature of the seat 270 may be determined using one or more infrared cameras (e.g., IR camera). The controller 220 may receive the data from the one or more infrared cameras for controlling the operation of the plurality of heaters/coolers.

### Temperature Sensors

In an example embodiment, the vehicle 200/500 includes a plurality of temperature sensors that detect temperature. A temperature sensor may be further configured to capture data regarding the temperatures that it detects. The temperature sensor may report (e.g., provide) the data that it captures to the controller 220. The temperature sensor may detect and provide data regarding temperature over any period of time. The temperature sensor may report capture data at any interval.

Each temperature sensor (e.g., 280, 282, 290, 292) detects the temperature of the area surrounding the temperature sensor. Each temperature sensor may capture and report the detected temperature to the controller 220. Each temperature sensor may send temperature data to the controller 220 via a wired and/or wireless communication link. Each temperature sensor may provide temperature data as an analog signal or as digital data. Each temperature sensor may provide temperature data continuously or periodically. A temperature sensor may detect the temperature of the material (e.g., plastic, metal, wood) proximate to the temperature sensor and/or the air proximate to the sensor. A temperature sensor may detect the temperature of the surface (e.g., interior wall, windshield, rear window, steering wheel) of the material proximate to the temperature sensor. A temperature sensor may be embedded in material to detect the temperature of the material. The vehicle 200/500 may include any number of temperature sensors. Temperature sensors may be positioned at any location in the vehicle 200/500.

In an example embodiment, the temperature sensors 280 are positioned on the driver-side of the vehicle 200/500 to detect the temperature of the material and/or the air on the driver-side of the vehicle 200/500. Temperature sensors 282 are positioned on the passenger-side of the vehicle 200/500 to detect the temperature of the material and/or the air on the passenger-side of the vehicle 200/500. Temperature sensor 290 is positioned in the seat 270 to detect the temperature of the seat 270. The seat 270 may include a plurality of temperature sensors 290. Temperature sensor 292 is positioned in the seat 272 to detect the temperature of the seat 272. The seat 272 may include a plurality of the temperature sensors 292. As discussed above, the controller 220 controls the HVAC to bring the air or a surface in the interior 260/560 to be at or near the desired temperature set by the user. The controller 220 controls the heater/cooler 240 and/or the heater/cooler 242 to bring the temperature of the seat 270 and/or the seat 272 to be at or near the desired temperature set by the user. In an embodiment that includes a plurality of temperature sensors in the interior 260/560, the controller 220 may combine the temperature data from the plurality of temperature sensors to determine whether the temperature of the interior 260/560 is at or near the desired temperature. The controller 220 may average the data to determine an average temperature. The controller 220 may compare the average temperature to the desired temperature to determine whether the interior 260/560 is at or near the desired temperature. The controller 220 may detect the lowest temperature, the highest temperature or the median temperature reported by the plurality of temperature sensors as representing the temperature of the interior 260/560. The controller 220 may similarly combine the temperature data from the plurality of temperature sensors 290 and/or the plurality of temperature sensors 292 to determine the temperature of the seat 270 or the seat 272 respectively. The data from a plurality of temperature sensors may be combined in any manner to determine a representative temperature.

In another example embodiment, the temperature in the interior 260/560 of the vehicle 200/500 is determined using one or more infrared cameras (e.g., IR cameras). The IR cameras provide data regarding the temperature of the air and objects on the interior 260/560 in three dimensions. The controller 220 uses the data from the IR cameras to determine the temperature of the air, surfaces and/or objects in the interior 260/560 of the vehicle 200/500. The one or more IR cameras may be positioned around the interior 260/560 of the vehicle 200/500 to provide a 3D picture of the temperature throughout the interior 260/560. The controller 220 receives the data from the one or more IR cameras. The controller 220 uses the data to determine the temperature of a specific location in the 3D volume of the interior 260/560.

### Central Environmental Controller

The central environmental controller 220, also referred to as the controller 220 herein, controls the operation of the HVAC system 210, the heater/cooler 240, the heater/cooler 242 and as discussed in further detail below dampers in accordance with the temperature data sensed by the temperature sensors 280 — 282, 290 and 292 and/or the one or more IR cameras.

In an example embodiment, the controller 220 controls the operation of the HVAC system 210, the heater/cooler 240, the heater/cooler 242 and the dampers to bring the interior 260/560, the seat 270 and the seat 272 to a desired temperature. In an example embodiment, the user sets a single desired temperature for the interior 260/560, for the seat 270 and for the seat 272. Setting one desired temperature instructs the controller 220 to operate the HVAC system 210, the heater/cooler 240, the heater/cooler 242 and the dampers to bring the interior 260/560, the seat 270 and the seat 272 to the same temperature. The interior 260/560, the seat 270 and the seat 272 do not necessarily reach the desired temperature at the same time. The controller 220 receives data from the temperature sensors 280 and 282 or the one or more IR cameras to determine when the interior 260/560 is at or near the desired temperature. When the interior 260/560 reaches the desired temperature, the controller 220 may cause the HVAC system to stop heating or cooling the driver-side airflow and/or the passenger-side airflow. When the temperature of the seat 270 or the seat 272 reaches the desired temperature, the controller 220 causes the heater/cooler 240 or the heater/cooler 242 respectively to stop heating or cooling the cover or cushion of the seat 270 and the seat 272 respectively. The controller 220 independently controls the HVAC system 210, the heater/cooler 240, the heater/cooler 242 and the dampers to maintain the interior 260, the seat 270 and the seat 272 at or near the desired temperature.

The phrase “at or near” refers to a range of temperature that includes the desired temperature. In an example embodiment, at or near means maintaining the temperature at the desired temperature plus or minus 2 degrees. The amount in the range that deviates from the desired temperature referred to as a threshold. So, the controller 220 operates to maintain the temperature of the interior 260/560, the seat 270 and the seat 272 at the desired temperature plus or minus a threshold (e.g., two degrees, three degrees, so forth). In an example embodiment, the threshold is a range of zero to three degrees.

### Single Desired Temperature

In an example of an embodiment that uses a single desired temperature to heat or cool the interior 260/560, a user sets the desired temperature to be 70° F. In a situation when the interior 260/560 of the vehicle 200/500, the seat 270 and the seat 272 are presently less than 70° F., the temperature sensors 280, 282, 290 and 292, or one or more RF cameras, initially report a detected temperature of less than 70° F. While the temperature sensors 280, 282, 290, 292 and/or RF cameras detect and report temperatures that are less than the desired temperature, the controller 220 activates the HVAC system 210, the heater/cooler 240, and/or the heater/cooler 242 to provide heat to increase the temperature in the interior 260, the seat 270 and/or the seat 272 respectively. The controller 220 continues to control the HVAC system 210, the heater/cooler 240, and/or the heater/cooler 242 to provide heat until the temperature sensors 280, 282, 290, 292 and/or RF cameras report a detected temperature at or near the desired temperature of 70° F. When the temperature sensors 280, 282, 290, 292 and/or RF cameras detect 70° F., within a threshold, the controller 220 instructs the HVAC system 210, the heater/cooler 240, and/or the heater/cooler 242 to cease heating. The interior 260/560, the seat 270 and the seat 272 may not reach the desired temperature at the same time, so the controller 220 individually controls the HVAC system 210, the heater/cooler 240 and/or the heater/cooler 242. The controller 220 further controls the HVAC system 210, the heater/cooler 240 and/or the heater/cooler 242 independent of each other to operate when needed to maintain the interior 260/560, the seat 270 and the seat 272 at or near the desired temperature. For example, the controller 220 may control the HVAC system 210 to still provide hot air after it has terminated the operation of the heater/cooler 240 and the heater/cooler 242 because the seat 270 and the seated 272 are at or near the desired temperature.

The controller 220 controls the HVAC system 210, the heater/cooler 240, and the heater/cooler 242 to bring the temperature of the interior 260/560, the seat 270, and the seat 272 to the desired temperature set by the user. The desired temperature provided by the user sets the temperature for both the interior 260/560 of the vehicle and the seats 270 and 272. The seats 270 and 272 are both controlled by the controller 220 and not by independent controllers (e.g., 130). Two controllers are independent of each other when they execute separate stored programs with no feedback or information from one controller to the other controller.

The driver-side airflow and the passenger-side airflow play a role in heating or cooling the seats 270 and 272. The temperature sensors 290 and 292 detect the temperature of the seat 270 and the seat 272 (e.g., cover, cushion, interior) respectively regardless of whether the seat 270 and/or the seat 272 are heated by the heater/cooler 240 and the heater/cooler 242 respectively or the driver-side airflow and/or passenger-side airflow. In other words, the heating or cooling of the seat 270 and the seat 272 is related to the heating and cooling of the interior 260/560 of the vehicle 200/500. When the interior 260/560, the seat 270 and/or the seat 272 reach the desired temperature, regardless of the source of heat or cooling, the controller 220 operates to maintain the interior 260/560, the seat 270 and the seat 272 at the desired temperature regardless of whether the HVAC system 210, the heater/cooler 240 or the heater/cooler 242 is operated to maintain the temperature. The temperature of the seats 270 and 272 are not set (e.g., 140) and/or controlled (e.g., 130) separate from the temperature of the interior 260/560. In other words, a common desired (e.g., target) temperature is used to control the HVAC system 210, the heater/cooler 240 and the heater/cooler 242.

In an example embodiment, the HVAC system 210 is used primarily to control the temperature of the interior 260/560 and the temperature of the seats 270 and 272. However, the heater/cooler 240 and the heater/cooler 242 assist the HVAC system 210 in bringing the seats 270 and 272 to the desired temperature more quickly than the HVAC system 210 alone. For example, on a cold winter morning, the HVAC system 210 can take a while to heat the interior 260/560 and the seats 270 and 272 to the desired temperature. However, after the user sets the desired temperature, the heater/cooler 240 and the heater/cooler 242 begin to heat the seats 270 and 272 so that the seats more rapidly reach the desired temperature than relying on the HVAC system 210 alone. Once the temperature of a seat has reached the desired temperature, its respective heater/cooler is turned off. Once the interior 260/560 has reached the desired temperature, the HVAC system 210 alone may be able to maintain the temperature of the interior 260, the seat 270 and the seat 272. The controller 220 may cycle the operation of the heater/coolers 240 and 242 to help maintain the temperature of the seats 270 and 272 at the desired temperature.

Similarly, the heater/cooler 240 and the heater/cooler 242 may assist to cool the seats 270 and 272 more quickly under hot conditions then HVAC system 210 alone. In another example embodiment, the controller 220 operates the HVAC system 210, the heater/cooler 240 and the heater/cooler 242 as needed to cool the interior 260/560, the seat 270 and the seat 272. The controller 220 cycles the operation of the HVAC system 210, the heater/cooler 240 and the heater/cooler 242 as needed to maintain the interior 260/560, the seat 270 and the seat 272 at or near the desired temperature.

### Driver-Side and Passenger-Side Desired Temperatures

In another example embodiment, the user sets a desired temperature for the driver-side (e.g., driver-side desired temperature) of the interior 260 and for the seat 270. The driver-side desired temperature is the same for the interior 260/560 on the driver-side and the seat 270. The user sets a desired temperature for the passenger-side (e.g., passenger-side desired temperature) of the interior 260/560 and for the seat 272. The passenger-side desired temperature is the same for the interior 260 on the passenger-side and the seat 272. The passenger-side desired temperature is the same for the interior 260/560 on the passenger-side and the seat 272. The driver-side desired temperature may be different from the passenger-side desired temperature.

Since the air in the interior 260/560 freely circulates, the final temperature of the air in the interior 260/560 may be somewhere between the driver-side desired temperature and the passenger-side desired temperature. However, since the heat or lack of heat of a seat does not easily transfer to the other seat, the temperature of the seat 270 may be different from the temperature of the seat 272. Further, the controller 220 may operate to maintain the different seat temperatures in accordance with the driver-side desired temperature and the passenger-side desired temperature.

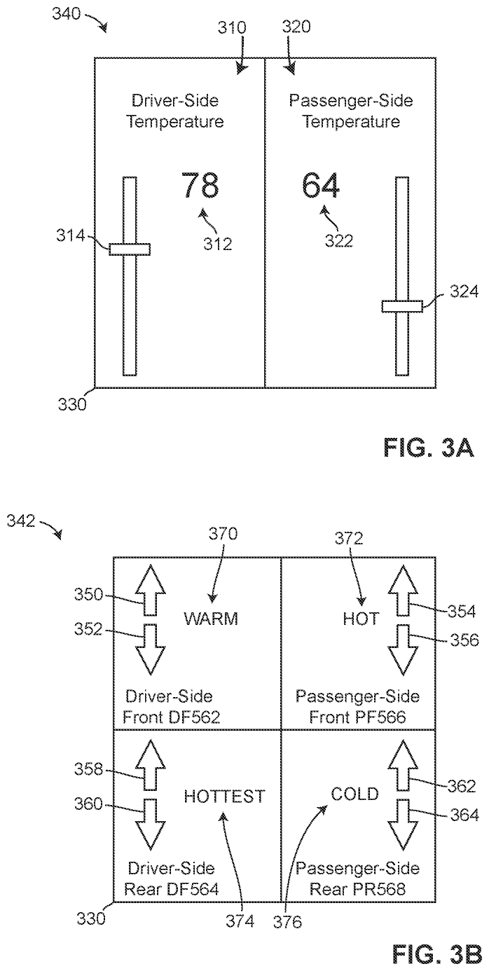

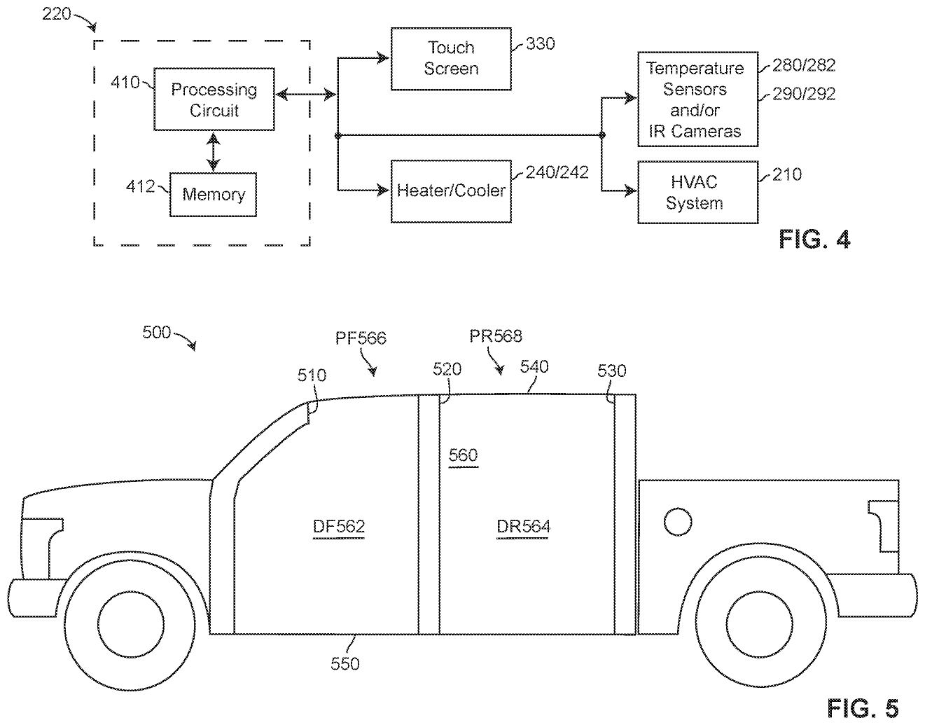

In an example embodiment, the user sets the driver-side desired temperature and the passenger-side desired temperature using icons presented on the touchscreen 330 of the environmental control interface 340 (e.g., user interface). The environmental control interface 340 presents information and an icon for a driver-side temperature 310 and a passenger-side temperature 320. As best shown in FIG. 3A, the user may set the driver-side desired temperature by moving slider 314 up to increase the driver-side desired temperature or down to decrease the driver-side desired temperature. The driver-side desired temperature as selected by the user is displayed on the touchscreen 330 as a driver-side desired temperature 312 (e.g., 78° F.). The user may set the passenger-side desired temperature by moving the slider 324 up to increase the passenger-side desired temperature or down to decrease the passenger-side desired temperature. The passenger-side desired temperature selected by the user is displayed on the touchscreen 330 as the passenger-side desired temperature 322 (e.g., 64° F.).

The driver-side desired temperature 312 and the passenger-side desired temperature 322 are provided to the controller 220. The controller 220 uses the driver-side desired temperature 312 to control the temperature of the airflow 230 from the HVAC system 210 and the heater/cooler 240 of the seat 270. The controller 220 controls the HVAC system 210 and the heater/cooler 240 to heat or cool the airflow 230 and at the seat 270 respectively to bring the driver-side of the interior 260 and the seat 270 to the driver-side desired temperature 312. The controller 220 controls the HVAC system 210 and the heater/cooler 242 to heat or cool the airflow 230 and at the seat 272 respectively to bring the passenger-side of the interior 260 and the seat 270 to the passenger-side desired temperature 322.

In an example embodiment, the temperature sensors 280 and 282 measure one or more surfaces on the driver-side and the passenger-side respectively of the interior 260/560, and not the air temperature, to detect the temperature of the driver-side and the passenger-side of the interior 260/560. The temperature sensors 290 and 292 are embedded in the seat 270 and the seat 272 respectively, so they fairly accurately represent the respective temperatures of the seats.

The controller 220 receives data from the temperature sensors 280 and 290 on the driver-side and data from the temperature sensors 282 and 292 on the passenger-side or from one or more IR cameras. The controller 220 compares the data from the temperature sensors 280 and 290, or IR camera, to the driver-side desired temperature 312 to determine when the driver-side of the interior 260/560 and the seat 270 have reached the driver-side desired temperature 312. The controller 220 compares the data from the temperature sensors 282 and 292, or IR camera, to the passenger-side desired temperature 322 to determine when the driver-side of the interior 260/560 and the seat 272 have reached the passenger-side desired temperature 322.

In another example embodiment, the user may specify a first offset to the driver-side desired temperature 312 and/or a second offset to the passenger-side desired temperature 322. The offset is an amount added to or subtracted from the desired temperature. The seat is heated to the desired temperature plus or minus the offset so that the temperature of the seat is different from the temperature of the air in the interior 260/560. For example, the controller 220 controls the HVAC system 210 to heat or cool the driver-side of the interior 260/560 to or near (e.g., within a threshold) the driver-side desired temperature 312 and the heater/cooler 240 to heat or cool the seat 270 to or near (e.g., within a threshold) the driver-side desired temperature 312 plus or minus the offset. Heating or cooling the seat 270 to or near the driver-side desired temperature 312 plus or minus the offset allows the user to have a seat temperature that is warmer or cooler than the driver-side of the interior 260/560. The controller 220 controls the HVAC system 210 and the heater/cooler 240 to maintain the driver-side of the interior 260 and the seat 270 at the different temperatures. For example, the offset is plus 5 degrees, so the controller 220 operates the heater/cooler 240 and the HVAC system 210 maintain the temperature of the seat 270 at a temperature that is 5 degrees higher than the temperature of the interior 260/560.

The second offset for the passenger-side desired temperature 322 accomplishes the same heating or cooling difference between the passenger-side of the interior 260/560 and the seat 272.

### Zone Desired Temperatures

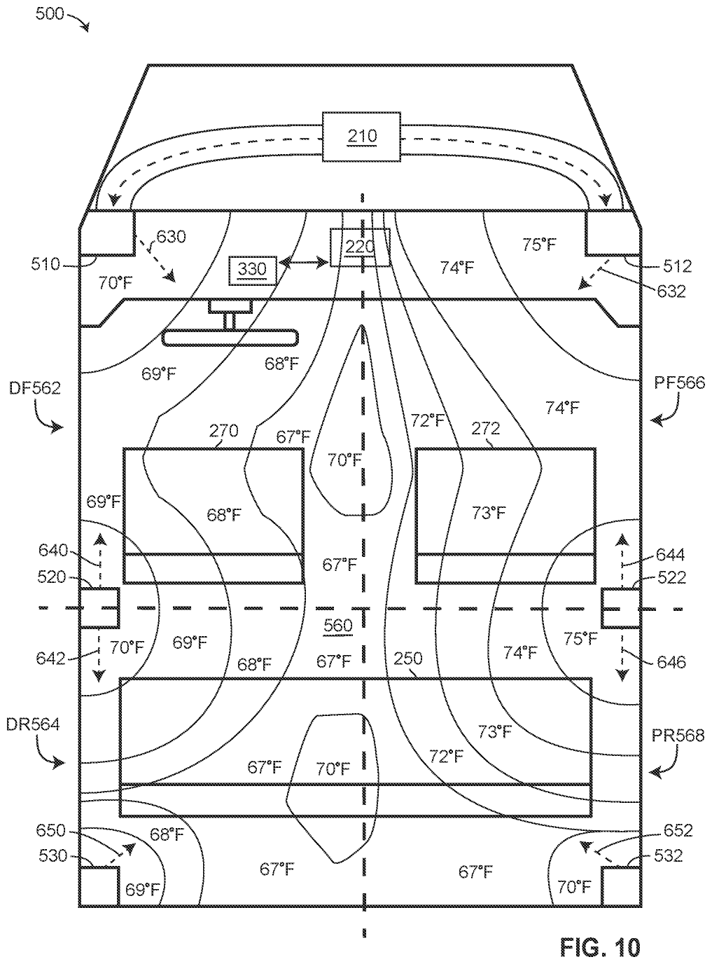

In another example embodiment, the user sets a desired temperature for different zones of the interior 560. In this example embodiment, the interior 560 is divided into four regions (e.g., zones): the driver-side front DF562, driver-side rear DR564, passenger-side front PF566 and passenger-side rear PR568 as best shown in FIG. 10. The user sets a desired temperature for each zone. The controller 220 controls the HVAC system 210, the dampers (not explicitly shown) to control the airflow through the ducts (e.g., 510, 520, 530, 610, 612, 710, 712, 810, 812) and the heater/coolers 240 and 242 to maintain desired temperatures for each zone and the seats (e.g., 270, 272, 250) in each zone. The sensors (e.g., 280, 282, 290, 292) and/or the IR cameras report the temperature for each zone. The temperature data from the sensors and/or the IR cameras may be configured into a temperature map by the controller 220. The temperature map maybe a three-dimensional (e.g., 3D) map of the temperature of the interior 560.

### Controller Example Embodiment

An example embodiment of the controller 220 (e.g., controller 220) includes a processing circuit 410, a memory 412, and the touchscreen 330. The processing circuit 410 communicates with and controls the operation of the HVAC system 210, the temperature sensors 280, 282, 290, 292 and/or IR cameras, and the heater/coolers 240 and 242.

As discussed above, the temperature sensors 280, 282, 290 and 292 and/or the IR cameras detect the temperature of the air in interior 260/560 or and/or a surface of the interior of vehicle 200/500, the temperature of the seat 270 and the temperature of the seat 272. The temperature data detected by the temperature sensors 280, 282, 290 and 292 and/or the IR cameras is reported to the processing circuit 410.

In an example embodiment, the touchscreen 330 receives information from the user regarding the desired temperature for the interior 260/560, the seat 270 and the seat 272. The touchscreen 330 provides the desired temperature to the processing circuit 410. The processing circuit 410 may store the desired temperature in the memory 412. In another example embodiment, the touchscreen 330 receives information from the user regarding the desired temperature of the interior 260/560 and an offset so that the seat 270 and/or the seat 272 are heated or cooled to the desired temperature plus or minus the offset. The processing circuit 410 receives the desired temperature and the offset from the touchscreen 330. The processing circuit 410 may store desired temperature and the offset in the memory 412.

In another example embodiment, the touchscreen 330 receives information from the user regarding the driver-side desired temperature for the driver-side of the interior 260/560 and the seat 270 (e.g., 312), and the passenger-side desired temperature for the passenger-side of the interior 260/560 and the seat 272 (e.g., 322). The processing circuit 410 receives the driver-side and passenger-side desired temperatures from the touchscreen 330. The processing circuit 410 may store the driver-side and passenger-side desired temperatures in the memory 412.

In another example embodiment, the touchscreen 330 receives information from the user regarding the driver-side desired temperature and a driver-side offset. The touchscreen 330 also receives information from the user regarding a passenger-side desired temperature and a passenger-side offset. The processing circuit 410 receives the driver-side desired temperature, the driver-side offset, the passenger-side desired temperature and the passenger-side offset. The processing circuit 410 may store the driver-side desired temperature, the driver-side offset, the passenger-side desired temperature and the passenger-side offset in the memory 412.

In another example embodiment, the touchscreen 330 receives information from the user regarding a desired temperature for the driver-side front DF562, driver-side rear DR564, passenger-side front PF566 and passenger-side rear PF568 regions of the interior 260/560. The processing circuit 410 receives the desired temperatures for the driver-side front DF562, driver-side rear DR564, passenger-side front PF566 and passenger-side rear PF568 regions and may store the desired temperatures in the memory 412.

The processing circuit 410 controls the HVAC system 210 to heat or cool the interior 260/560 as a whole (e.g., single desired temperature), as driver-side and passenger side (e.g., driver-side desired temperature, passenger-side desired temperature) or as regions (e.g., desired temperatures for DF562, DR564, PF566, PF568 regions). The processing circuit further controls the heater/cooler 240 and the heater/cooler 242 to heat or cool the seat 270 and 272 to the desired temperature (e.g., driver-side, passenger-side, DF562 region, PF566 region) including our not including an offset. The seat 250 may also have one or more heater/coolers that are controlled by the processing circuit 410 in accordance with an appropriate desired temperature.

In an example embodiment, the processing circuit 410 controls the touchscreen 330 to receive information from and present information to the driver. In the example shown in FIG. 3A, the environmental control interface 340 is presented on the touchscreen 330, so the user may set the driver-side temperature 310 and the passenger-side temperature 320. The processing circuit 410 controls the touchscreen 330 to present the sliders 314 and 324 to receive the driver-side and the passenger-side desired temperature information from the user. The user manipulates the sliders 314 and 324 to provide the driver-side desired temperature 312 and the passenger-side desired temperature 322 respectively to the processing circuit 410 via the touchscreen 330. A method for entering a driver-side offset or a passenger-side offset is not shown in FIG. 3A; however, the information is entered via the touchscreen 330 and provided to the processing circuit 410. The processing circuit 410 uses the driver-side desired temperature 312 and the passenger-side desired temperature 322 to control the HVAC system 210, the heater/cooler 240, and the heater/cooler 242 as discussed above.

In another example embodiment, best seen in FIG. 3B, the environmental control interface 342 present arrows 350-364 for increasing or decreasing the temperature of the driver-side front DF562, passenger-side front PF566, driver-side rear DR 564 and passenger-side rear PR568 regions. Instead of using numbers to represent the desired temperature of each region, the environmental control interface 342 presents relative temperature descriptions: called, cool, warm, hot and hottest. The up arrows (e.g., 350, 354, 358, 362) and down arrows (e.g., 352, 356, 360, 364) are pressed to increase or decrease respectively the desired temperature for the DF562, PF566, DR564 and PR568 regions respectively. The desired temperatures (e.g., 370, 372, 374, 376) for each region are presented.

The processing circuit 410 may execute a stored program to perform the functions of the controller 220. The program executed by the processing circuit 410 may be stored in the memory 412. The processing circuit 410 may also store and retrieve data to and from the memory 412 respectively. For example, the desired temperature, the offset, the driver-side desired temperature, the passenger-side desired temperature, the driver-side offset and/or the passenger-side offset may be stored in the memory 412 as mentioned above.

In another example embodiment, the touchscreen 330 may be replaced by a display (e.g., monitor, LCD screen, segmented display) for presenting information to the user and a touchpad for receiving information from the user. The user may move their finger up or down on the touchpad to control the position of the sliders 314 and 324 of the environmental control interface 340. The user may press an upper portion of the touchpad or a lower portion of the touchpad to activate the up arrows (e.g., 350, 354, 358, 362) and down (e.g., 352, 356, 360, 364) arrows respectively of the environmental control interface 342. In another example embodiment, the siders and arrows of the environmental control interfaces 340 and 342 may be implemented using electro-mechanical controls (e.g., sliders, buttons).

### Surround Airflow

In the example embodiment of the vehicle 200, the HVAC system 210 provides conditioned air via ducts located in the front of the vehicle, primarily from the dashboard while the seats were heated or cooled using the heater/coolers 240 and 242. In the example embodiment of the vehicle 500, the HVAC system 210 provides airflow via ducts that substantially surround the interior of the vehicle while the seats 270 and/or 272 are heated/cooled primarily using the heater/coolers 240 and 242. The seat 250 may also be heated or cooled using one or more heater/coolers. In some example embodiments of the vehicle 500, air from the HVAC system 210 heats or cools the seats 250, 270, 272 sufficiently so that the heater/coolers 240 and 242 may be omitted.

In an embodiment in which the HVAC system 210 provides air via a plurality of ducts that substantially surround the interior of the vehicle, the controller 220 controls HVAC system 210 and the heater/coolers 240 and 242 if present. The controller 220 may further control the amount of flow of air and the temperature of the air that flows through a particular duct. For example, the controller 220 may control dampers (not shown) that control the amount of flow of air through one or more ducts.

Further, the information from the temperature sensors 280, 282, 290 and 292 and/or the IR cameras may be used to create a map of the temperature (e.g., temperature map) of the interior 260/560 of the vehicle. The controller 220 may use the temperature map in combination with the desired temperature (e.g., single, driver-side, passenger-side, regions) to control airflow through the ducts and the temperature of the air that flows through the ducts to heat or cool particular areas of the interior 260/560 to reach the desired temperature.

In an embodiment that includes a plurality of ducts (e.g., vehicle 500), the flow of air need not be as high (e.g., strong, forceful) is in an embodiment where the ducts are primary located in the dashboard (e.g., vehicle 200). Further, in an embodiment that includes a plurality of ducts, the interior 560 may be divided into zones (e.g., driver-side, passenger-side, DF562, DR564, PF566, PR568) where different zones may be maintained at different temperatures within reason. Further, the controller 220 may monitor the information of the temperature map to try to maintain the different zones at the desired temperature for the zone. Any number of temperature sensors (e.g., 280, 282, 290, 292, IR cameras) may be positioned throughout the interior 260/560 to detect the temperature of the air and/or surfaces. Each temperature sensor may detect and represent a particular portion of the interior in the temperature map. Further, sensors may be included in the interior of the seat 250 to control of the temperature of the seat 250.

### A Plurality of Ducts

The drawings of the vehicle 500 in FIGS. 5-10 identify the A-pillars 510 and 512, the B-pillars 520 and 522, the C-pillars 530 and 532 on the driver side and passenger side respectively, the roof 540, the floor 550 and the interior 560. The interior 560 is divided into four zones: driver-side front DF562, driver-side rear DR564, passenger-side front PF566 and passenger-side rear PR568. Most vehicles include at least two A-pillars and two B-pillars. Longer vehicles include tow C-pillars and possibly two D-pillars. The concepts taught herein are applicable to vehicles that include any number of pillars.

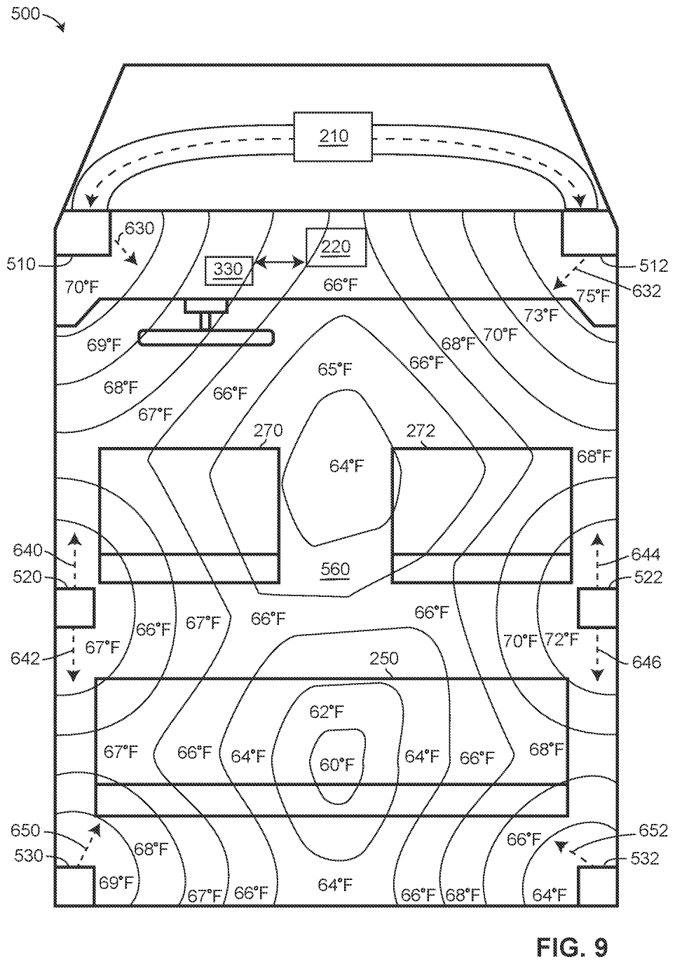

Generally, the interior of a pillar is hollow to reduce the weight of the vehicle. The hollow interior of a pillar may be used as a duct to transport conditioned air. Only the A-pillar, B-pillar and C-pillar on the driver's side are shown in FIGS. 5-8, while a top view of the driver-side and passenger-side pillars are shown in FIGS. 9 and 10. The roofs of a vehicle may include ducts, such as inside (e.g., through) the headliner. The floors of a vehicle may also include ducts. Air may exit a duct via an outlet into the interior 560. An outlet may be positioned at any location (e.g., position) along the duct. Air may flow from one duct to another duct to provide air distribution around and/or throughout the interior 560.

Any number of dampers may be positioned between the ducts and/or on the outlets to regulate the flow of air between the ducts and/or out of an outlet into the interior 560. Dampers are not explicitly shown in the drawing but may be positioned at any location to control any flow of air. Some dampers at outlets may be controlled manually by user. However, most dampers are controlled by the controller 220. The controller 220 controls the dampers to regulate the flow of air in the interior 560 and toward the seats 270, 272 and 250. The controller 220 may control dampers to regulate the flow of air in accordance with the temperature map. The controller 220 may control dampers to increase or decrease the temperature of a flow through a particular duct and thereby the temperature of a portion of the vehicle 500.

### First Embodiment of a Plurality of Ducts

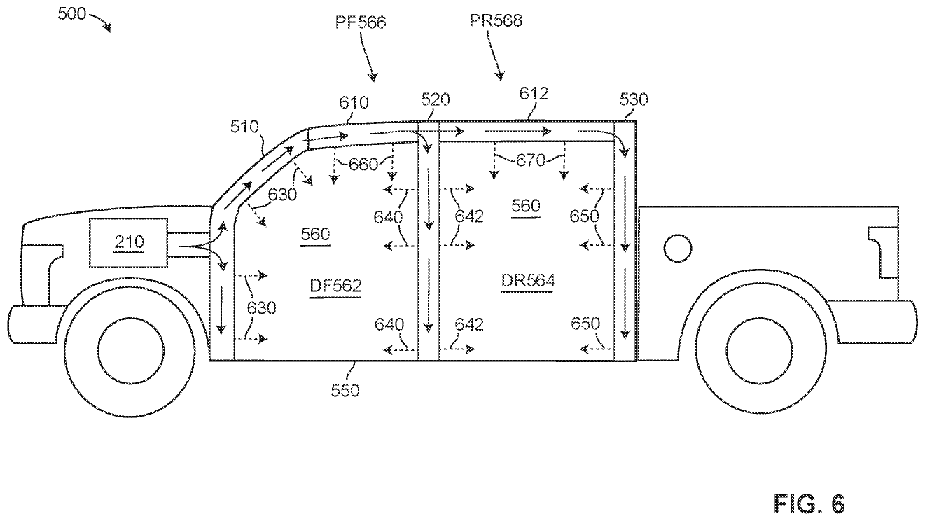

In an example embodiment, as best seen in FIG. 6, the vehicle 500 includes a roof duct 610 and a roof duct 612 along with ducts through the A-pillars 510 and 512, the B-pillars 520 and 522, and the C-pillars 530 and 532. The vehicle 500, in this embodiment, may further include dampers between the A-pillar 510/512 and the roof duct 610, the roof duct 610 and the roof duct 612, the roof duct 612 and the C-pillar 530/532, and the roof duct 610 and the B-pillars 520/522. The roof ducts 610 and 612 may be positioned between the metal roof of the vehicle 500 and the roof liner of the vehicle 500 or in the roof liner. Air flows from the A-pillars 510/512, the roof duct 610, the B-pillar 520/522, the roof duct 612 and the C-pillar 530/532 as airflows 630, 632, 660, 640, 642, 644, 646, 670, 650 and 652 respectively. Airflows 630, 632, 660 and 640 provide air primarily to the driver-side front region DF562. Airflows 642, 670 and 650 provide air primarily to the driver-side rear region DR564. Similarly, airflows 632, 670 and 644, and 646, 670 and 652 provide air to the passenger-side front PF566 and the passenger-side rear PR568 regions respectively.

In this embodiment, a portion of airflow 640 is directed toward the seat 270. The airflow may be used to heat or cool the seat 270; however, heating and cooling of the seat 270 may benefit from the heater/cooler 240. Accordingly, the heater/cooler 240 and 242 are not omitted from the seats 270 and 272.

### Second Embodiment of a Plurality of Ducts

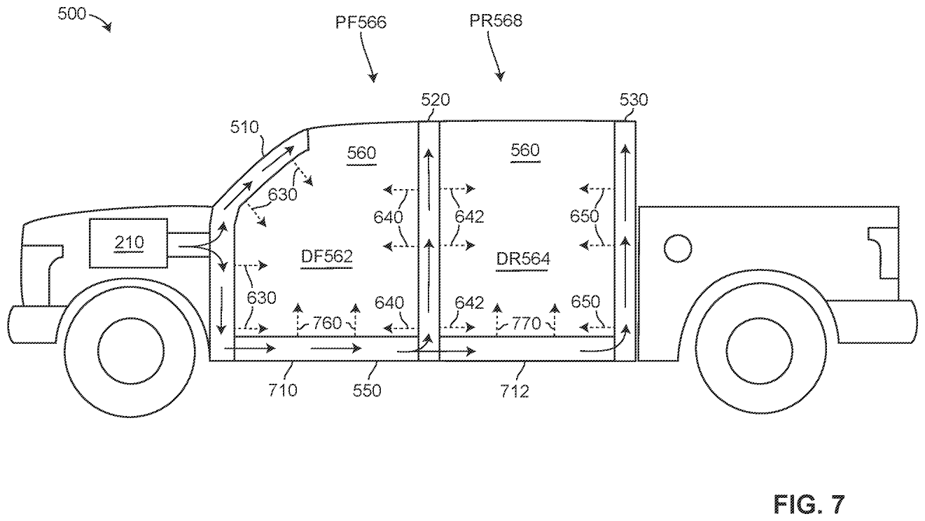

In another example embodiment, as best seen in FIG. 7, the vehicle 500 includes a floor duct 710 and a floor duct 712 along with ducts through the A-pillar 510/512, the B-pillar 520/522 and the C-pillar 530/532. The vehicle 500, in this embodiment, may further include dampers between the A-pillars 510/512 and the floor duct 710, the floor duct 710 and the floor duct 712, the roof duct 612 and the C-pillars 530/532 and the floor duct 710 and the B-pillars 520/522. The floor ducts 710 and 712 may be positioned beneath the metal floor of the vehicle 500 on an exterior of the vehicle 500 and/or between the exterior floor and an interior floor. The floor ducts 710 and 720 may span the width of the interior 560 or be comprised of a plurality of smaller (e.g., narrow) floor ducts 710 and floor ducts 712. Air flows via outlets from the A-pillars 510/512, the floor duct 710, the B-pillars 520/522, the floor duct 712 and the C-pillars 530/532 as airflows 630, 632, 760, 640, 642, 644, 646, 770, 650 and 652 respectively. Airflows 630, 760 and 640 provide air primarily to the driver-side front region DF562. Airflows 642, 770 and 650 provide air primarily to the driver-side rear zone DR564. Airflows 632, 760 and 644 provide air primarily to the passenger-side front region DF566. Airflows 646, 770 and 652 provide air primarily to the passenger-side rear zone DR568.

In this embodiment, a portion of airflow 760 is directed toward and even upward into the interior of the seat 250, the seat 270 and/or the seat 272. The outlets from the floor duct 710 may be positioned directly underneath the seat 250, the seat 270 and/or the seat 272, so that the air that flows from those ducts directly heats or cools the seats 250, 270 and/or 272. Outlets that direct air from the floor ducts 710 and 712 toward a seat may include dampers that assist in controlling airflow to and the temperature of the seats. The seats 250, 270 and 272 may include ducts internal to the seat that fit over an outlet from the floor ducts 710 or 712. Air from the floor ducts 710 or 712 may flow into ducts that are positioned inside the seats. The ducts inside the seats may have outlets that direct air into or against a cover and/or cushion of the seat thereby heating or cooling the seat using air from the HVAC system 210. In this embodiment, the heater/coolers 240 and 242 may be omitted from the seat 270 and 272 because the air provided by the HVAC system 210 via the plurality of ducts heats or cools the seats.

### Third Embodiment of a Plurality of Ducts

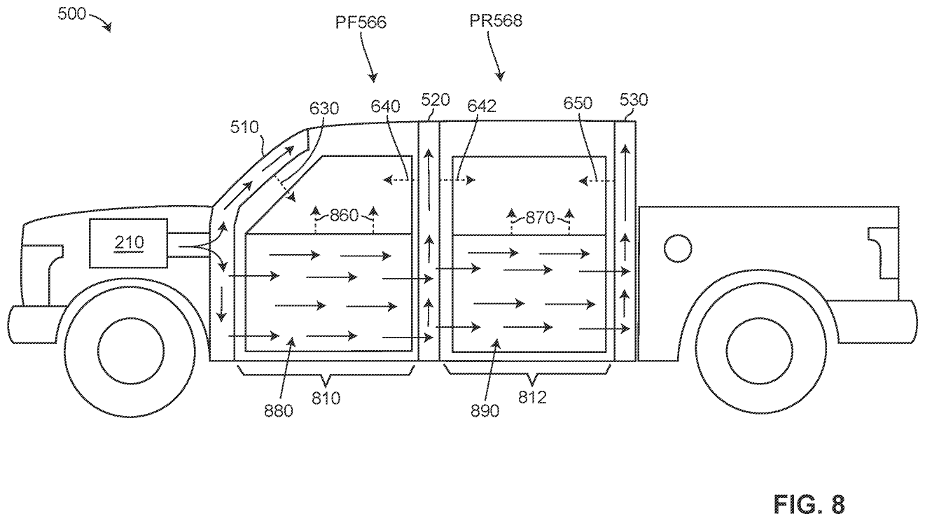

In another example embodiment, best shown in FIG. 8, the vehicle 500 includes the doors 810 and 812 which are hollow or include ducts that permit the passage of air through the inside of the doors and out of the doors into the interior 560 via outlets. The doors 810 and 812 may be hollow so that air flows into the door on one end, through a major portion of the door, and out the door at the other end. The doors 810 and 812 may include ducts inside the door that direct the flow of air through and out the door. Air flows through a door or a duct inside a door from one pillar to another pillar. Air may flow through a door or a duct inside a door to a roof or floor duct. Air flow out of the door at any location of the door (e.g., top, middle, front, back, bottom).

In this example embodiment, the hollow interiors of the doors 810 and 812 serve as ducts along with the A-pillars 510/512, the B-pillars 520/522 and the C-pillars 530/532 to distribute air around and into the interior 560. The vehicle 500, in this embodiment, may further include dampers between the A-pillars 510/512 and the door 810, the door 810 and the B-pillars 520/522, the B-pillars 520/522 and the door 812, the door 812 and the C-pillars 530/532. Air flows from the A-pillars 510/512, the door 810, the B-pillars 520/522, the door 812 and the C-pillars 530/532 as airflows 630, 860, 640, 642, 644, 646, 870, 650 and 652 respectively. Airflows 630, 860 and 640 provide air primarily to the driver-side front zone DF562. Airflows 642, 870 and 650 provide air primarily to the driver-side rear zone DR564. Airflows 632, 860 and 644 provide air primarily to the passenger-side front region DF566. Airflows 646, 870 and 652 provide air primarily to the passenger-side rear region DR568.

In this embodiment, a portion of airflow 860 and airflow 870 are directed toward the seat 270 and the seat 250 respectively. It is possible that airflow 860 and airflow 870 are sufficient heat or cool the seat 270 and the seat 250; however, heating and cooling of the seats (e.g., seat 270) may benefit from a heater/cooler (e.g., heater/cooler 240) inside the seat. Accordingly, the heater/coolers 240 and 242 are not omitted from the seats 270 and 272.

### Combination of Embodiments

The ducts from any of the above embodiments may be included in a new embodiment. For example, the vehicle 500 may include any combination of pillar ducts, roof ducts, floor ducts and door ducts. For example, the vehicle 500 may use the A-pillars 510/512, the B-pillars 520/522, the C-pillars 530/532, the roof duct 610, the roof duct 612, the floor duct 710, the floor duct 712, the door 810 and the door 812. In another embodiment, the vehicle 500 includes the A-pillars 510/512, the B-pillars 520/522, the C-pillars 530/532, the floor duct 710 and the roof duct 612. Any combination of ducts may be used that circulates air around and into a majority of the interior 560.

### Temperature Map

As discussed above, temperature sensors (e.g., 280, 282, 290, 292) and/or the IR cameras may be placed anywhere in the interior 560 to detect the temperature of the air, an object or a surface. The temperature sensors and/or the IR cameras may provide data to the controller 220. The controller 220 may prepare a temperature map, as best seen in FIGS. 9 and 10 of the interior 560 based on the location of the temperature sensors and their respective detected temperature or on the IR cameras. The controller 220 may use the temperature map to determine whether a desired temperature for the entirety of the interior 560, the driver-side and passenger-side desired temperatures, or the desired temperatures for the DF562, DR564, PF566 and PR568 regions have been reached.

In FIGS. 9 and 10, the temperature sensors 280, 282, 290 and 292 and the heater/coolers 240 and 242 are not shown for improving the clarity of the temperature map. Further, of the plurality of possible ducts, only a top view of the A-pillars 510/512, B-pillars 520/522 and C-pillars 530/532 are shown.

With respect to the temperature map of FIG. 9, the controller 220 can determine the actions to take to reach (e.g., the at or near) the desired temperature specified by the user. For example, if the user has specified a single desired temperature for the interior 560, say for example 65 degrees, the controller 220 can determine from the temperature map that the temperature presently exiting the outlets of the pillar ducts is sufficiently high to warm the 60-degree center of the interior 560 with time. If the user has specified a driver-side desired temperature of 65 degrees and a passenger-side desired temperature of 70 degrees, the controller 220 can determine that a large swath of the driver-side is close to the driver-side desired temperature, but the temperature of the passenger-side needs to be increased. Pursuant to the analysis of the temperature map, the controller 220 may leave the temperature and the volume of the air exiting the outlets of the pillar ducts on the driver-side as currently set. For the passenger-side, the controller 220 may increase either the volume of the air exiting the outlets of the pillar ducts on the passenger-side or increase the temperature of the air delivered to the pillar ducts on the passenger side (e.g., 512, 522, 532). Because the movement of air in the interior 560 is dynamic, the controller 220 will need to continually monitor and make adjustments to the amount of flow in the ducts and the temperature of the air in the ducts to reach the desired temperatures.

Because the conditioned air from the HVAC system 210 is delivered to the interior 560 via a plurality of ducts, the velocity of the airflow through the plurality of ducts does not need to be as high as the velocity of the air delivered primarily through outlets located in the dashboard. For example, for a duct whose outlet is positioned near the dashboard to deliver conditioned air to the rear of the vehicle, the air must exit the outlet of the duct at a high velocity to reach the back of the vehicle. Air that is delivered through a duct to an outlet positioned in the rear of the vehicle may exit the outlet at a much lower velocity because the duct has delivered the conditioned air to the rear of the vehicle for release from an outlet positioned in the rear of the vehicle. The velocity of air through a duct may be modulated (e.g., controlled) by dampers that control the flow of air through the duct or through the speed of the fan that supplies air to the duct. If one duct feeds (e.g., provides, supplies) other ducts, the speed of the fan may need to be increased to supply the flow of air through the ducts positioned serially and dampers used to control the speed of the air exiting the outlets of the ducts.

The HVAC system 210 may include a plurality of fans the drive conditioned air into the plurality of ducts. The controller 220 may control the plurality of fans to provide air to different ducts at different velocities. The controller 220 may control the temperature of the air provided by the HVAC system 210 to the plurality of ducts so that the temperature of air in some ducts is greater than the temperature of air in other ducts. The controller 220 may control the temperature and/or the velocity of the air in the plurality of ducts to bring the interior 560, or a portion thereof, to a desired temperature.

Providing conditioned air to the interior 560 at reduced velocity means that the controller 220 may more effectively control the temperature in regions of the vehicle because there is less turbulence and mixing of the air at the boundaries of the regions. Further, delivering air through a plurality of ducts that include a plurality of dampers that are controlled by the controller 220 increases control of the air delivered to the different zones of the vehicle. For example, as best seen in FIG. 10, the A-pillar 510, the A-pillar 512, the C-pillar 530 and the C-pillar 532 deliver conditioned air to primarily set the temperature of the driver-side front DF562, passenger-side front DF566, driver-side rear DR564 and passenger-side rear PR568 regions. The B-pillars 520 and 522 maybe either closed by dampers or provide conditioned air at a temperature that lies between the desired temperatures of the driver-side front DF562/driver-side rear DR564 and passenger-side front PF566/passenger-side rear PR568 regions.

### Afterword

The foregoing description discusses embodiments (e.g., implementations), which may be changed or modified without departing from the scope of the present disclosure as defined in the claims. Examples listed in parentheses may be used in the alternative or in any practical combination. As used in the specification and claims, the words ‘comprising’, ‘comprises’, ‘including’, ‘includes’, ‘having’, and ‘has’ introduce an open-ended statement of component structures and/or functions. In the specification and claims, the words ‘a’ and ‘an’ are used as indefinite articles meaning ‘one or more’. While for the sake of clarity of description, several specific embodiments have been described, the scope of the invention is intended to be measured by the claims as set forth below. In the claims, the term “provided” is used to definitively identify an object that is not a claimed element but an object that performs the function of a workpiece. For example, in the claim “an apparatus for aiming a provided barrel, the apparatus comprising: a housing, the barrel positioned in the housing”, the barrel is not a claimed element of the apparatus, but an object that cooperates with the “housing” of the “apparatus” by being positioned in the “housing”.

The location indicators “herein”, “hereunder”, “above”, “below”, or other word that refer to a location, whether specific or general, in the specification shall be construed to refer to any location in the specification whether the location is before or after the location indicator.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods.

What is claimed is:

1. A system for controlling a temperature of a cabin and a seat of a vehicle, the system comprising:
a controller;
an HVAC system configured to heat or cool an air in the cabin of the vehicle;
a first temperature sensor positioned in the cabin of the vehicle, the first temperature sensor configured to detect a first temperature of the air or a surface inside the cabin, the first temperature sensor further configured to report a first data regarding the first temperature to the controller;
a heater/cooler positioned in an interior of the seat of the vehicle, the heater/cooler configured to heat or cool a cover or a cushion of the seat; and
a second temperature sensor positioned in the interior of the seat of the vehicle, the second temperature sensor configured to detect a second temperature of the cover or the cushion of the seat, the second temperature sensor further configured to report a second data regarding the second temperature to the controller; wherein:
the controller is configured to receive a desired temperature from a user of the vehicle, the controller is further configured to control the HVAC system and the heater/cooler in accordance with the desired temperature, the first data and the second data to maintain the first temperature of the air or surface in the cabin and the second temperature of the cover or the cushion of the seat at or near the desired temperature.

2. The system of claim 1 wherein:
the controller comprises a processing circuit and a touchscreen; and
processing circuit receives the desired temperature from the user via the touchscreen.

3. The system of claim 1 wherein:
the desired temperature comprises a first desired temperature and a second desired temperature; and
the controller is configured to control the HVAC system in accordance with the first desired temperature and the first data to maintain the first temperature of the air or the surface in the cabin at or near the first desired temperature.

4. The system of claim 1 wherein:
the desired temperature comprises a first desired temperature and a second desired temperature; and
the controller is configured to control the heater/cooler in accordance with the second desired temperature and the second data to maintain the second temperature of the cover or the cushion of the seat at or near the second desired temperature.

5. The system of claim 1 wherein:
the desired temperature comprises a first desired temperature and a second desired temperature;
the controller is configured to control the HVAC system in accordance with the first desired temperature and the first data to maintain the first temperature of the air or the surface in the cabin at or near the first desired temperature; and
the controller is further configured to control the heater/cooler in accordance with the second desired temperature and the second data to maintain the second temperature of the cover or the cushion of the seat at or near the second desired temperature.

6. The system of claim 5 wherein the first desired temperature is different from the second desired temperature.

7. The system of claim 1 wherein the controller is configured to maintain the second temperature of the cover or the cushion of the seat at or near the desired temperature plus or minus an offset.

8. The system of claim 7 wherein the offset is in a range of 1 to 10 degrees.

9. A system for controlling a temperature of a cabin and a seat of a vehicle, the system comprising:
an HVAC system configured provide a flow of air to heat an air into the cabin of the vehicle;
a first temperature sensor positioned in the cabin of the vehicle, the first temperature sensor configured to detect a first temperature of the air or a surface inside the cabin;
a heating element positioned in an interior of the seat of the vehicle, the heating element configured to heat a cover or a cushion of the seat; and
a second temperature sensor positioned in the interior or under the cover of the seat of the vehicle, the second temperature sensor configured to detect a second temperature of the cover or the cushion of the seat; and
a controller configured to receive a desired temperature from a user of the vehicle, the controller configured to control a third temperature of the flow of air from the HVAC system in accordance with the first temperature and the desired temperature to maintain the first temperature at or near the desired temperature, the controller further configured to control a fourth temperature of the heating element in accordance with the second temperature and the desired temperature to maintain the second temperature at or near the desired temperature.

10. The system of claim 9 wherein the controller is further configured to maintain the second temperature at or near the desired temperature plus or minus an offset.

11. The system of claim 9 wherein:
the first temperature sensor comprises a first plurality of temperature sensors, each temperature sensor of the first plurality of temperature sensors is positioned at a respective position in the cabin;
each temperature sensor of the first plurality of temperature sensors detects a respective temperature at its respective position in the cabin; and
the controller determines the first temperature in accordance with the respective temperatures detected by the first plurality of temperature sensors.

12. The system of claim 11 wherein the controller averages the respective temperatures detected by the first plurality of temperature sensors to determine the first temperature.

13. The system of claim 11 wherein the controller uses a lowest temperature of the respective temperatures detected by the first plurality of temperature sensors as the first temperature.

14. The system of claim 11 wherein the controller uses a highest temperature of the respective temperatures detected by the first plurality of temperature sensors as the first temperature.

15. The system of claim 9 wherein:
the second temperature sensor comprises a second plurality of temperature sensors, each temperature sensor of the second plurality of temperature sensors is positioned at a respective position in the interior or under the cover of the seat;
each temperature sensor of the second plurality of temperature sensors detects a respective temperature at its respective position in the interior or under the cover of the seat; and
the controller determines the second temperature in accordance with the respective temperatures detected by the second plurality of temperature sensors.

16. The system of claim 15 wherein the controller averages the respective temperatures detected by the second plurality of temperature sensors to determine the second temperature.

17. The system of claim 15 wherein the controller uses a lowest temperature of the respective temperatures detected by the second plurality of temperature sensors as the second temperature.

18. The system of claim 15 wherein the controller uses a highest temperature of the respective temperatures detected by the second plurality of temperature sensors as the second temperature.

19. The system of claim 9 wherein:
the controller comprises a processing circuit and a touchscreen;
the processing circuit receives the desired temperature from the user via the touchscreen; and
the processing circuit is configured to control the HVAC system and the heating element.
